(19) United States
(12) Patent Application Publication
(10) Pub. No.: US 2017/0190091 A1
(43) Pub. Date: Jul. 6, 2017

(54) TEMPERATURE PROBE, PARTICULARLY FOR THERMOPLASTIC MIX EXTRUSION MACHINES

(71) Applicant: SEMPLICE S.P.A., Milano (IT)

(72) Inventor: Stefano Paoletti, Folignano (IT)

(73) Assignee: SEMPLICE S.P.A., Milano (IT)

(21) Appl. No.: 15/245,802

(22) Filed: Aug. 24, 2016

(30) Foreign Application Priority Data
Sep. 18, 2015 (IT) 102015000052801

(51) Int. Cl. B29C 47/92; G01K 1/08; G01K 7/02

(52) U.S. Cl. CPC B29C 47/92; G01K 7/02; G01K 1/08; B29C 2947/92209; B29C 2947/924; B29K 2101/12

(57) ABSTRACT

A temperature probe, particularly for thermoplastic mix extrusion machines, which comprises at least one casing, which is adapted to be inserted in an extrusion cylinder substantially at right angles to the extrusion direction with one end thereof facing into the internal cavity of the extrusion cylinder so that it is in direct contact with the extrusion material contained in the internal cavity, and at least one thermocouple, which is accommodated in the casing and is adapted to detect the temperature of the extrusion material by thermal conduction through the casing, the temperature probe comprising thermally insulating elements which are interposed at least partially between the casing and the extrusion cylinder so as to reduce the thermal influence of the extrusion cylinder on the measurement made by the thermocouple.

The present invention relates to a temperature probe, particularly for thermoplastic mix extrusion machines.

Currently, international regulations covering self-extinguishing or flame-retardant wires (HFFR, Halogen Free Flame Retardant) and wires with low fume emissions and no halogens in the event of combustion (LSOH, Low Smoke Zero Halogen), have led the makers of compounds to produce thermoplastic mixes that are difficult to work with, owing to the great quantity of heat that is generated during the processing of such thermoplastic mixes owing to their high viscosity. The excess of heat suffers the drawback of leading to the degradation of the material proper.

Such thermoplastic mixes are usually processed in extrusion machines which, faced with the above mentioned technical difficulties and owing to the particular composition of the mixes themselves, have extrusion speeds reduced by 50% or more, with respect to the processing of conventional thermoplastic mixes, with consequent reduction in productivity and rise in costs.

Furthermore, the temperature control systems are not sufficiently efficient for processing thermoplastic mixes that are difficult to work with, i.e. for those mixes whose degradation temperature is proximate to their working temperature, which entail a reduction of the production speed so that the operators can make sure that such degradation temperature is not reached.

Therefore it becomes necessary to use temperature control systems with temperature sensors which however are very often inaccurate for the measurement of the temperature of the working material.

In order to overcome these drawbacks, special temperature probes have been developed which are constituted by a commercial thermocouple embedded in a casing made of mechanically strong heat-conducting material.

In this way, the probe can be inserted directly into the cavity of the extrusion cylinder, by way of a radial hole therein, making the free end of the casing face the extrusion material, in direct contact with it. Thus, by thermal conduction, the thermocouple can measure the temperature of the extrusion material through the casing more reliably than the temperature sensors mentioned earlier.

However, even such temperature probe is not devoid of drawbacks, among which is the fact that, since the casing is screwed into a radial hole that passes through the wall of the extrusion cylinder, the temperature of the latter can significantly influence the measurement taken by the thermocouple.

In fact, the extrusion cylinder typically has operating temperatures that are different from the temperatures of the extrusion material, in that the temperature delta “ΔT”, i.e. the difference between the aforementioned temperatures, makes it possible to add or remove heat to/from the extrusion material. Therefore, since the casing is in contact with the extrusion cylinder, the heat emanated by the latter can be diffused directly to the thermocouple, thus altering the measurement taken.

Another drawback of conventional temperature probes consists in that they have a high thermal inertia, as a consequence making the casing dynamically slow in transferring heat from the extrusion material to the thermocouple, in particular during operations to vary the screw-turns and flow-rate required by the production cycle.

In fact, since the casing has to be sufficiently dimensioned to withstand the mechanical stresses to which it is subjected, the dimensions of the casing are quite large.

Furthermore, in order to substitute the casing, with conventional temperature probes it is necessary to insert them in position before the final machining of the extrusion cylinder, so that the protruding part is ground with the same radius of curvature of the cylinder.

In fact, in these special temperature probes the casing is screwed into the extrusion cylinder without a definite position of arrest. As a consequence, in order to eliminate any recesses that are created between the rectilinear part of the casing of the thermocouple and the curved surface of the cavity of the extrusion cylinder, which would lead to the formation of areas of stagnation which are particularly damaging in thermoplastic mixes that degrade easily, like HFFR and LSOH mixes, but also in conventional mixes such as PVC, PE, PP etc., in the event of substitution of such casing it is necessary to repeat the grinding operation in order to have the correct curvature on the head of the casing.

The aim of the present invention consists in providing a temperature probe, particularly for thermoplastic mix extrusion machines, that solves the above mentioned technical problems, by eliminating the drawbacks and overcoming the limitations of the known art so as to enable the optimization of productivity of the extrusion line, thus increasing the speed of processing and the dynamic of response.

Within this aim, an object of the present invention is to provide a temperature probe that makes it possible to perform measurements with a high degree of precision and control.

Another object of the invention consists in providing a temperature probe that is capable of offering the widest guarantees of reliability and safety in use.

Another object of the invention consists in providing a temperature probe that is highly reliable, easily and practically implemented and economically competitive, including in use, when compared to the known art.

This aim and these and other objects which will become better apparent hereinafter are achieved by a temperature probe, particularly for thermoplastic mix extrusion machines, which comprises at least one casing, which is adapted to be inserted in an extrusion cylinder substantially at right angles to the extrusion direction with one end thereof facing into the internal cavity of said extrusion cylinder so that it is in direct contact with the extrusion material contained in said internal cavity of said extrusion cylinder, and at least one thermocouple, which is accommodated in said at least one casing and is adapted to detect the temperature of said extrusion material by thermal conduction through said at least one casing, characterized in that it comprises thermally insulating means which are interposed at least partially between said at least one casing and said extrusion cylinder, so as to reduce the thermal influence of said extrusion cylinder on the measurement made by said at least one thermocouple.

Further characteristics and advantages of the invention will become better apparent from the detailed description of a preferred, but not exclusive, embodiment of a temperature probe, particularly for thermoplastic mix extrusion machines, illustrated by way of non-limiting example in the accompanying drawings wherein:

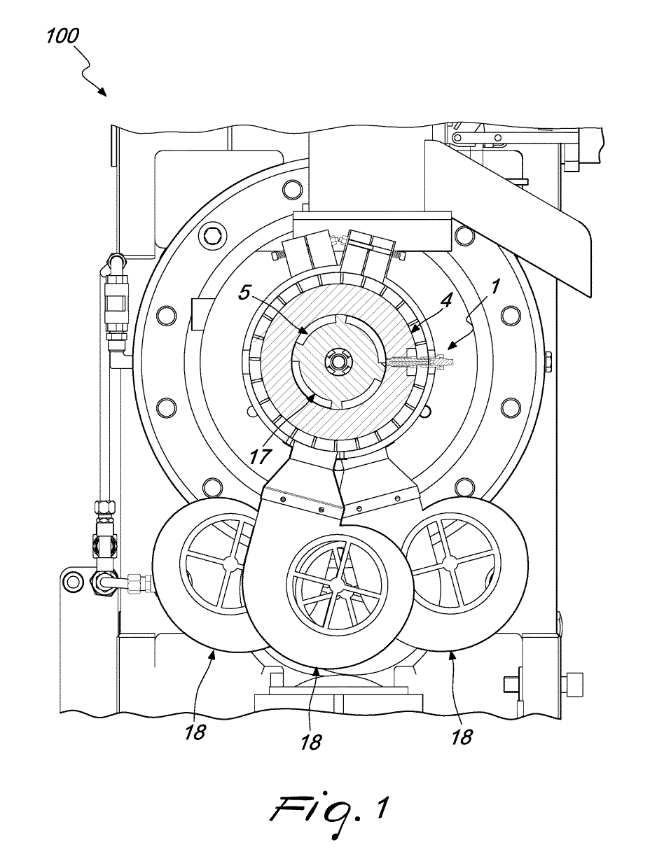

FIG. 1 is a cross-sectional view of a temperature probe, particularly for thermoplastic mix extrusion machines, applied in an extrusion machine, according to the invention;

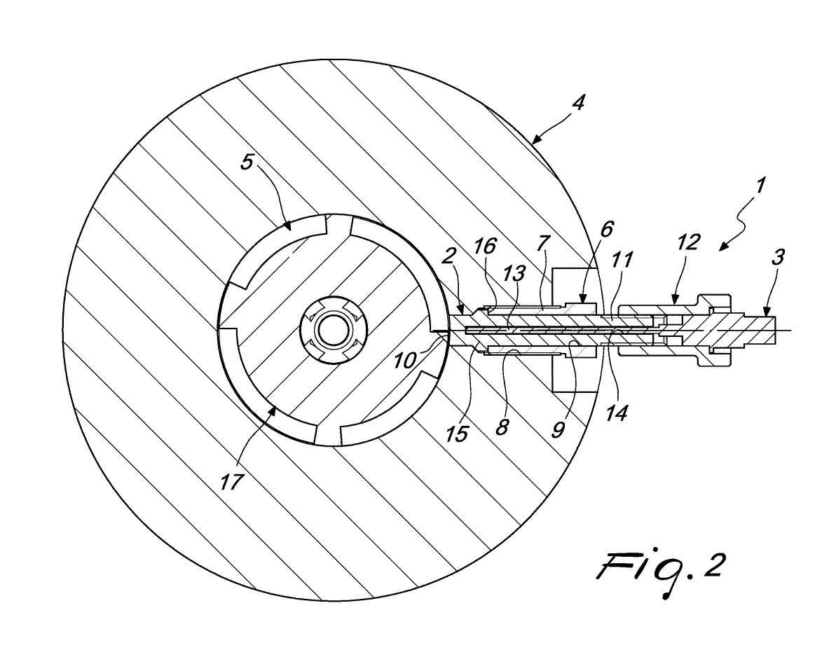

FIG. 2 is an enlarged-scale detail of the temperature probe, particularly for thermoplastic mix extrusion machines, according to the invention, shown in FIG. 1.

With reference to the figures, the temperature probe, particularly for thermoplastic mix extrusion machines, generally designated by the reference numeral 1, comprises at least one casing 2 and at least one thermocouple 3 which is accommodated internally in the casing 2.

As will be better described hereinafter, the casing 2 is adapted to be inserted in an extrusion cylinder 4 substantially at right angles to the extrusion direction with one end thereof facing into the internal cavity 5 of the extrusion cylinder 4 so that it is in direct contact with the extrusion material contained in the internal cavity 5.

Considering the thermocouple 3, the latter is adapted to detect, by thermal conduction through the casing 2, the temperature of the extrusion material circulating in the cavity 5.

According to the invention, thermally insulating means 6 are comprised which are interposed at least partially between the casing 2 and the extrusion cylinder 4 so as to reduce the thermal influence of the latter on the measurement made by the thermocouple 3.

More specifically, the thermally insulating means 6 comprise at least one bushing 7, which for example can be made at least partially or completely of stainless steel so as to offer high mechanical strength with low heat transmission capacity, and which has a calibrated hole 9 adapted to accommodate the central portion of the casing 2 and is externally threaded and adapted to be screwed into a partially threaded through hole 8 which is defined in the extrusion cylinder 4 radially thereto.

Both the material and the shape of the casing 2 contribute to the mechanical strength to withstand high pressures and thermal conduction. The casing 2 must in fact withstand pressures of the order of 1000 bar and temperatures of the order of 400° C.

In a preferred embodiment of the invention, the casing 2 can be made at least partially or completely of an alloy of copper, tin and beryllium, for its characteristics of resistance to abrasion, resistance to corrosion, and mechanical strength.

Advantageously, the casing 2 has a shape that is elongated along a preferred direction, with the end intended to come into contact with the extrusion material having a concave surface 10 which reproduces the curvature of the internal wall of the extrusion cylinder 4.

By way of the possible adjustments of the bushing 7 and of the presence of a shoulder 16 in abutment with the bushing 7, the casing 2, and therefore the corresponding concave surface 10, can be correctly positioned with respect to the inner curvature of the extrusion cylinder 4, so as to have perfect continuity of the curve of the extrusion cylinder 4, without recesses or protrusions which would be a cause of areas of stagnation. The other end of the casing 2, which is visible outside the extrusion cylinder 4 and is therefore not in contact with the extrusion material, can advantageously also have a shoulder for the correct angular positioning, both visual and instrumental, of the casing 2.

Furthermore, the threaded coupling of the bushing 7 with the through hole 8 ensures the seal of the temperature probe 1, offering resistance to the pressure of the material up to and over 1000 bar.

The other end of the casing 2 defines instead a threaded shank 11 which is engaged with an element 12 for supporting and adjusting the thermocouple 3, in which the latter is slideably inserted so that the sensitive end 13 of the thermocouple 3 is accommodated in contact in a recess 14 which is defined internally and longitudinally to the casing 2.

In this way, it is possible to adjust the positioning of the thermocouple 3 in the casing 2 according to the geometric characteristics of the thermocouple 3 and, therefore, of the different lengths of the thermocouples 3 available on the market.

Furthermore, in this way operations of substitution and/or maintenance of the thermocouple 3 are facilitated, since it is possible to intervene thereon even with the extrusion machine in production, and therefore even with the extrusion material being processed inside it under pressure.

Furthermore, the casing 2 comprises a radially widened portion 15 which is defined between the concave surface 10 and the central portion and is engaged with the bushing 7.

The radially widened portion 15 has a geometric shape structure that is preferably frustum-shaped, with the smaller cross-section directed toward the concave surface 10, and is intended to engage by shape mating with a radially narrower portion of the through hole 8 which is defined between the internal surface of the extrusion cylinder 4 and the threaded portion of the through hole 8.

In more detail, such radially narrower portion has a geometric shape structure that is substantially complementary to the radially widened portion 15 of the casing 2 for centering by conical coupling the temperature probe 1 in the through hole 8 and the perfect seal from the high operating pressures to which the temperature probe 1 is subjected.

Operation of the temperature probe 1, according to the present invention, is clear and can be easily understood from the foregoing description.

In particular, it should be noted that it can be used, for example, in an extrusion machine, particularly for thermoplastic mixes, generally designated in FIG. 1 with the reference numeral 100, which comprises an extrusion cylinder 4, an extrusion screw 17, at least one heating element associated with the extrusion cylinder 4, and at least one cooling fan 18 engaged with the outer surface of the extrusion cylinder 4.

The presence of a temperature probe 1 which faces in the cavity 5 which originates between the internal surface of the extrusion cylinder 4 and the outer surface of the extrusion screw 17, i.e. which is in direct contact with the thermoplastic mix undergoing processing, ensures the accurate and rapid measurement of the temperature of the mix.

Starting from such measurement of temperature of the mix, a control thermoregulator assembly, fitted on board the machine, controls, for example with controls of the PID (Proportional-Integral-Derivative) type, the operation of the heating elements and of the cooling fans, in order to maintain the desired temperature for processing the thermoplastic mix.

In practice it has been found that the temperature probe, particularly for thermoplastic mix extrusion machines, according to the present invention, achieves the intended aim and objects in that it makes it possible to improve the productivity of the extrusion line, by increasing the speed of production and the quality of the production, with respect to the known art, since it is possible to effectively monitor the temperature of the thermoplastic mix being processed.

Another advantage of the temperature probe, according to the invention, consists in that the temperature readings of the thermoplastic mix being processed are very accurate and are transmitted practically immediately, allowing a temperature control of the working temperature with no significant delays, by way of the low thermal inertia of the casing and of the thermal insulation offered by the bushing against the extrusion cylinder.

The temperature probe, particularly for thermoplastic mix extrusion machines, thus conceived is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

In conclusion, the scope of protection of the claims shall not be limited by the explanations or by the preferred embodiments illustrated in the description by way of examples, but rather the claims shall comprise all the patentable characteristics of novelty that reside in the present invention, including all the characteristics that would be considered as equivalent by the person skilled in the art.

The disclosures in Italian Patent Application No. 102015000052801 (UB2015A003734) from which this application claims priority are incorporated herein by reference.

What is claimed is:

1. A temperature probe, particularly for thermoplastic mix extrusion machines, which comprises at least one casing, which is adapted to be inserted in an extrusion cylinder substantially at right angles to the extrusion direction with one end thereof facing into the internal cavity of said extrusion cylinder so that it is in direct contact with the extrusion material contained in said internal cavity of said extrusion cylinder, and at least one thermocouple, which is accommodated in said at least one casing and is adapted to detect the temperature of said extrusion material by thermal conduction through said at least one casing, comprising thermally insulating means which are interposed at least partially between said at least one casing and said extrusion cylinder, so as to reduce the thermal influence of said extrusion cylinder on the measurement made by said at least one thermocouple.

2. The temperature probe according to claim 1, wherein said thermally insulating means comprise at least one externally threaded bushing which is adapted to be screwed into a partially threaded through hole which is defined in said extrusion cylinder radially thereto, said bushing being provided with a calibrated hole which is adapted to accommodate the central portion of said at least one casing.

3. The temperature probe according to claim 1, wherein said at least one casing has a shape that is elongated along a preferred direction, with the end intended to come into contact with said extrusion material having a concave surface which reproduces the curvature of the internal wall of said extrusion cylinder.

4. The temperature probe according to claim 1, wherein said at least one casing has the other end defining a threaded shank which is engaged with an element for the support and adjustment of said at least one thermocouple, said at least one thermocouple being inserted slideably into said support and adjustment element, with the sensitive end of said at least one thermocouple accommodated in contact in a recess defined internally and longitudinally to said at least one casing, and in such a manner as to be able to adjust the arrangement of said at least one thermocouple in said at least one casing according to the geometric characteristics of said at least one thermocouple.

5. The temperature probe according to claim 3, wherein said at least one casing comprises a radially widened portion which is defined between said concave surface and said central portion and is intended to engage by shape mating with a radially narrower portion of said through hole which is defined between said internal surface of said extrusion cylinder and said threaded portion of said through hole.

6. The temperature probe according to claim 5, wherein said radially widened portion has a frustum-like geometric shape, with the smaller cross-section directed toward said concave surface, said radially narrower portion of said through hole having a geometric shape that is substantially complementary to said radially widened portion of said at least one casing for centering by conical coupling said temperature probe in said through hole.

7. The temperature probe according to claim 1, wherein said at least one casing is at least partly made of an alloy of copper, tin and beryllium.

8. The temperature probe according to claim 2, wherein said at least one bushing is at least partially made of stainless steel.

9. The extrusion machine, particularly for thermoplastic mixes, comprising said extrusion cylinder, an extrusion screw, at least one heating element associated with said extrusion cylinder, and at least one cooling fan which is engaged with the external surface of said extrusion cylinder, comprising at least one temperature probe according to claim 1.
